(19) United States
(12) Patent Application Publication
(10) Pub. No.: US 2026/0197899 A1
(43) Pub. Date: Jul. 9, 2026

(54) INTELLIGENT DISCONTINUOUS RECEPTION (DRX) WAKE-UP AND WARM-UP IN MIXED CARRIER AGGREGATION

(71) Applicant: QUALCOMM Incorporated, San Diego, CA (US)

(72) Inventors: Arnab PAL, Hyderabad (IN); Rishav AGARWAL, Howrah (IN)

(21) Appl. No.: 19/128,091

(22) PCT Filed: Nov. 21, 2023
(86) PCT No.: PCT/US2023/080786

§ 371 Date: May 7, 2025

(30) Foreign Application Priority Data
Dec. 12, 2022 (IN) 202241071586

(51) Int. Cl. H04W 76/28

(52) U.S. Cl. CPC H04W 76/28

(57) ABSTRACT

Aspects relate to techniques for providing joint discontinuous reception (DRX) warm-up occasions in mixed carrier aggregation (CA) scenarios in which a user equipment (UE) is communicating with different cells using different radio access technologies (RATs), each associated with a different frequency range (e.g., FR1 and FR2). The UE may identify respective warm-up occasions for each of the RATs that occur in a different DRX cycles. The UE may further modify at least one of the warm-up occasions to provide a joint warm-up occasion during the same DRX cycle to perform tracking loop updates for each of the RATs.

### CROSS-REFERENCE TO RELATED APPLICATIONS

The present Application for Patent claims priority to pending Indian Application No. 202241071586, filed Dec. 12, 2022, and assigned to the assignee hereof and hereby expressly incorporated by reference herein as if fully set forth below and for all applicable purposes.

### TECHNICAL FIELD

The technology discussed below relates generally to wireless communication networks, and more particularly, to modifying discontinuous reception warm-up timing in mixed carrier aggregation scenarios.

### INTRODUCTION

In wireless communication systems, such as those specified under standards for 5G New Radio (NR), a user equipment (UE) may operate in a discontinuous reception (DRX) mode. The DRX mode allows the UE to remain in a low-power state, such as a sleep state, for a period of time. Between sleep periods, the UE may wake-up (e.g., perform a power-up operation) to enter an active state and communicate with the network. The UE may enter the DRX mode in a radio resource control (RRC) connected state (connected mode DRX (C-DRX)) or an RRC idle state (idle mode DRX (I-DRX)). In C-DRX, the UE may be configured with a DRX ON duration and a DRX OFF duration. During the DRX ON duration, the UE may wake-up and monitor for a physical downlink control channel (PDCCH) and transmit or receive user data traffic. In I-DRX, the UE may periodically wake-up during DRX ON durations to receive a page based on a paging cycle.

Wireless communication networks may further utilize a coordinated multi-point (CoMP) network configuration in which transmissions from multiple transmission points (TRPs) may be simultaneously directed towards a UE. In a multi-TRP transmission scheme, multiple TRPs may or may not be co-located and may or may not be within a same cell. Each of the multiple TRPs may transmit the same or different data to a user equipment (UE). When transmitting different data from the multiple TRPs, a higher throughput may be achieved. When transmitting the same data (with potentially different redundancy versions) from the multiple TRPs, transmission reliability may be improved.

In some examples, each TRP may utilize the same carrier frequency to communicate with a UE. In other examples, each TRP may utilize a different carrier frequency (referred to as a component carrier) and carrier aggregation may be performed at the UE. In this example, the multi-TRP transmission scheme may be referred to as a multi-carrier or multi-cell transmission scheme. In a multi-carrier or multi-cell transmission scheme, there are a number of serving cells, each utilizing a different component carrier for communication with the UE. One of the serving cells may be referred to as a Primary serving cell (PCell), while the other serving cells may be referred to as Secondary serving cells (SCells). The PCell maintains the primary connection with the UE and is responsible for the radio resource control (RRC) connection setup.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In one example, a user equipment (UE) configured for wireless communication is disclosed. The UE includes a wireless transceiver, a memory, and a processor coupled to the wireless transceiver and the memory. The processor is configured to communicate with a first cell using a first radio access technology (RAT) associated with a first frequency range and a second cell using a second RAT associated with a second frequency range in a discontinuous reception (DRX) mode and to identify a first warm-up occasion for the first RAT and a second warm-up occasion for the second RAT in the DRX mode. The second warm-up occasion can occur in a different DRX cycle than the first warm-up occasion. The processor is further configured to modify at least one of the first warm-up occasion or the second warm-up occasion to provide a joint warm-up occasion during a same DRX cycle for both the first RAT and the second RAT.

Another example provides a method for wireless communication at a user equipment. The method includes communicating with a first cell using a first radio access technology (RAT) associated with a first frequency range and a second cell using a second RAT associated with a second frequency range in a discontinuous reception (DRX) mode and identifying a first warm-up occasion for the first RAT and a second warm-up occasion for the second RAT in the DRX mode. The second warm-up occasion can occur in a different DRX cycle than the first warm-up occasion. The method further includes modifying at least one of the first warm-up occasion or the second warm-up occasion to provide a joint warm-up occasion during a same DRX cycle for both the first RAT and the second RAT.

Another example provides a UE including means for communicating with a first cell using a first radio access technology (RAT) associated with a first frequency range and a second cell using a second RAT associated with a second frequency range in a discontinuous reception (DRX) mode and identifying a first warm-up occasion for the first RAT and a second warm-up occasion for the second RAT in the DRX mode. The second warm-up occasion can occur in a different DRX cycle than the first warm-up occasion. The UE further includes means for modifying at least one of the first warm-up occasion or the second warm-up occasion to provide a joint warm-up occasion during a same DRX cycle for both the first RAT and the second RAT.

These and other aspects will become more fully understood upon a review of the detailed description, which follows. Other aspects, features, and examples will become apparent to those of ordinary skill in the art, upon reviewing the following description of specific, exemplary examples of in conjunction with the accompanying figures. While features may be discussed relative to certain examples and figures below, all examples can include one or more of the advantageous features discussed herein. In other words, while one or more examples may be discussed as having certain advantageous features, one or more of such features may also be used in accordance with the various examples discussed herein. In similar fashion, while exemplary examples may be discussed below as device, system, or method examples such exemplary examples can be implemented in various devices, systems, and methods.

### BRIEF DESCRIPTION OF THE DRAWINGS

FIG. 1 is a schematic illustration of a wireless communication system according to some aspects.

FIG. 2 is a conceptual illustration of an example of a radio access network according to some aspects.

FIG. 3 is a diagram illustrating an example of a frame structure for use in a radio access network according to some aspects.

FIG. 4 is a diagram illustrating an example of idle mode discontinuous reception (I-DRX) according to some aspects.

FIG. 5 is a diagram illustrating an example of connected mode discontinuous reception (C-DRX) according to some aspects.

FIG. 6 is a diagram illustrating a multi-cell transmission environment according to some aspects.

FIG. 7 is a diagram illustrating an example of mixed CA DRX wake-up and warm-up according to some aspects.

FIG. 8 is a diagram illustrating an example of reduced warm-up occasions in DRX mode for mixed CA scenarios according to some aspects.

FIG. 8 is a diagram illustrating another example of reduced warm-up occasions in DRX mode for mixed CA scenarios according to some aspects.

FIG. 10 is a block diagram illustrating an example of a hardware implementation for a user equipment (UE) employing a processing system according to some aspects.

FIG. 11 is a flow chart of an exemplary method for modifying DRX warm-up timing in mixed carrier aggregation scenarios according to some aspects.

FIG. 12 is a flow chart of an exemplary method for performing tracking loop updates using modified DRX warm-up timing in mixed carrier aggregation scenarios according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, examples and/or uses may come about via integrated chip examples and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, disaggregated arrangements, end-user devices, etc. of varying sizes, shapes and constitution.

Various aspects of the disclosure relate to techniques for providing DRX joint warm-up occasions in mixed carrier aggregation (CA) scenarios. A mixed CA scenario may involve a UE communicating with a first cell using a first radio access technology (RAT) associated with a first frequency range (FR), such as FR1, and communicating with a second cell using a second RAT associated with a second FR, such as FR2. In DRX mode, the UE may periodically perform tracking loop updates, such as time tracking loop (TTL) updates and frequency tracking loop (FTL) updates, during warm-up occasions in which the UE powers on (wakes up) to receive reference signals, such as synchronization signal blocks (SSBs), and to update the tracking loops based on the received SSBs. For mixed CA scenarios, each RAT may have a different wake-up periodicity for performing the tracking loop updates, which may result in the UE waking up more frequently to perform tracking loop updates than otherwise would occur if the wake-up periodicities between the RATs were the same. Therefore, in various aspects, the UE can modify a respective warm-up occasion of at least one of the RATs to provide a joint warm-up occasion during a same DRX cycle for both of the RATs.

In some examples, the UE may derive a joint wake-up periodicity for each of the RATs based on the individual wake-up periodicities of each of the RATs. For example, the joint wake-up periodicity may correspond to the maximum or minimum of the individual wake-up periodicity, the average of the individual wake-up periodicities, or any other joint wake-up periodicity between the respective individual wake-up periodicities. In some examples, the UE may further modify the joint wake-up periodicity based on channel conditions of at least one of the RATs.

In some examples, prior to a first warm-up occasion for a first RAT, the UE may perform an evaluation of one or more key performance indicators (e.g., channel conditions, beam rotation, UE sensor inputs, etc.) for a second RAT. Based on the evaluation, the UE may modify a second warm-up occasion of the second RAT to occur within the same DRX cycle as the first warm-up occasion to provide a joint warm-up occasion for both RATs. In addition, the UE may skip the next one or more warm-up occasions for the second RAT based on the wake-up periodicity of the second RAT.

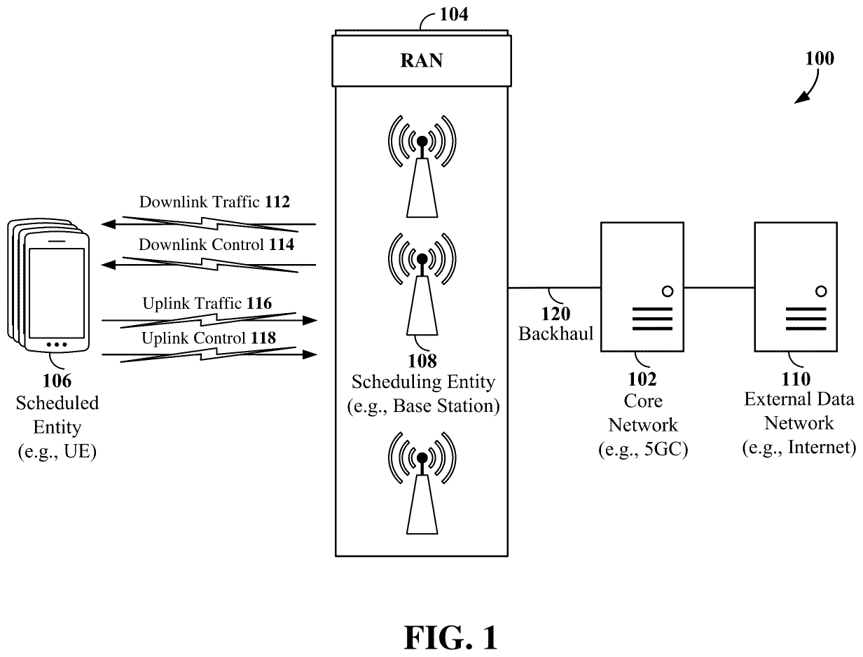

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as Long Term Evolution (LTE). The 3GPP refers to this hybrid RAN as a next-generation RAN, or NG-RAN. Of course, many other examples may be utilized within the scope of the present disclosure.

As illustrated, the RAN 104 includes a plurality of network entities 108, which may correspond, for example, to aggregated and/or disaggregated base stations. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency band. In examples where the RAN 104 operates according to both the LTE and 5G NR standards, one of the base stations may be an LTE base station, while another base station may be a 5G NR base station.

The RAN 104 is further illustrated supporting wireless communication for multiple mobile apparatuses. A mobile apparatus may be referred to as user equipment (UE) in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus (e.g., a mobile apparatus) that provides a user with access to network services.

Within the present disclosure, a “mobile” apparatus need not necessarily have a capability to move and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, TX chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT).

A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, and/or agricultural equipment, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between the RAN 104 and the UE 106 may be described as utilizing an air interface. Transmissions over the air interface from a base station (e.g., base station 108) to one or more UEs (e.g., similar to UE 106) may be referred to as downlink (DL) transmissions. In accordance with certain aspects of the present disclosure, the term downlink may refer to a point-to-multipoint transmission originating at a base station (e.g., base station 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a UE (e.g., UE 106).

In some examples, access to the air interface may be scheduled, wherein a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities (e.g., UEs 106). That is, for scheduled communication, a plurality of UEs 106, which may be scheduled entities, may utilize resources allocated by the scheduling entity 108.

Base stations 108 are not the only entities that may function as scheduling entities. That is, in some examples, a UE may function as a scheduling entity, scheduling resources for one or more scheduled entities (e.g., one or more other UEs). For example, UEs may communicate directly with other UEs in a peer-to-peer or device-to-device fashion (e.g., via sidelinks) and/or in a relay configuration.

As illustrated in FIG. 1, a scheduling entity 108 may broadcast downlink traffic 112 to one or more scheduled entities (e.g., one or more UEs 106). Broadly, the scheduling entity 108 is a node or device responsible for scheduling traffic in a wireless communication network, including the downlink traffic 112 and, in some examples, uplink traffic 116 from one or more scheduled entities (e.g., one or more UEs 106) to the scheduling entity 108. On the other hand, the scheduled entity (e.g., a UE 106) is a node or device that receives downlink control 114 information, including but not limited to scheduling information (e.g., a grant), synchronization or timing information, or other control information from another entity in the wireless communication network such as the scheduling entity 108. The scheduled entity (e.g., a UE 106) may transmit uplink control 118 information including one or more uplink control channels to the scheduling entity 108. Uplink control 118 information may include a variety of packet types and categories, including pilots, reference signals, and information configured to enable or assist in decoding uplink data transmissions.

In addition, the uplink and/or downlink control information and/or traffic information may be transmitted on a waveform that may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, base stations 108 may include a backhaul interface for communication with a backhaul portion 120 of the wireless communication system 100. The backhaul portion 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100 and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

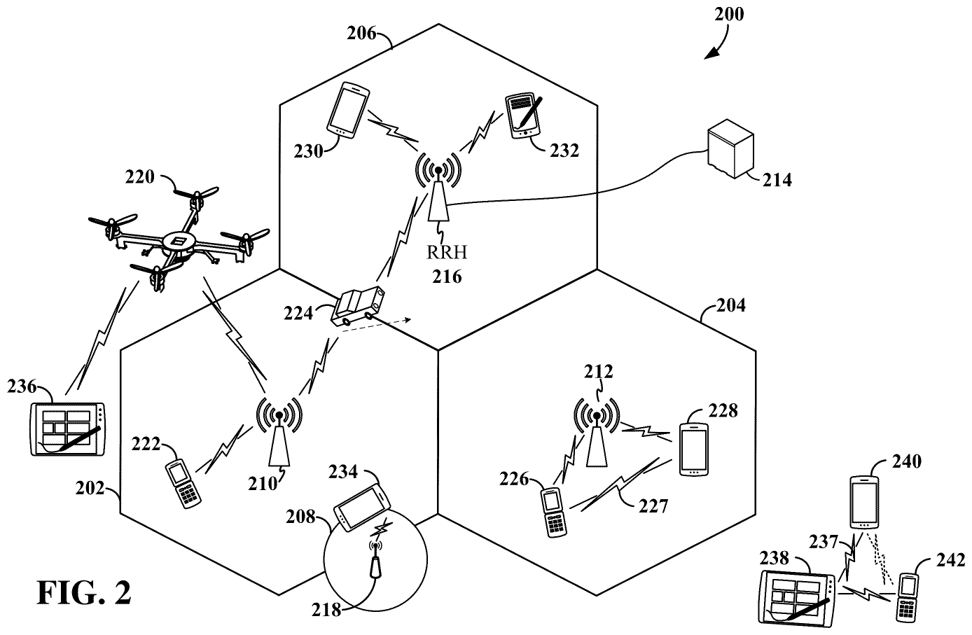

Referring now to FIG. 2, as an illustrative example without limitation, a schematic illustration of an example of a radio access network (RAN) 200 according to some aspects of the disclosure is provided. In some examples, the RAN 200 may be the same as the RAN 104 described above and illustrated in FIG. 1.

The geographic region covered by the RAN 200 may be divided into a number of cellular regions (cells) that can be uniquely identified by a user equipment (UE) based on an identification broadcasted over a geographical area from one access point or base station (e.g., aggregated or disaggregated). FIG. 2 illustrates cells 202, 204, 206, and 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various network entity (e.g., base station) arrangements can be utilized. For example, in FIG. 2, two base stations, base station 210 and base station 212 are shown in cells 202 and 204. A third base station, base station 214, is shown controlling a remote radio head (RRH) 216 in cell 206. That is, a base station can have an integrated antenna or can be connected to an antenna or RRH 216 by feeder cables. In the illustrated example, cells 202, 204, and 206 may be referred to as macrocells, as the base stations 210, 212, and 214 support cells having a large size. Further, a base station 218 is shown in the cell 208, which may overlap with one or more macrocells. In this example, the cell 208 may be referred to as a small cell (e.g., a microcell, picocell, femtocell, home base station, home Node B, home eNode B, etc.), as the base station 218 supports a cell having a relatively small size. Cell sizing can be done according to system design as well as component constraints.

It is to be understood that the RAN 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as or similar to the scheduling entity 108 described above and illustrated in FIG. 1.

FIG. 2 further includes an unmanned aerial vehicle (UAV) 220, which may be a drone or quadcopter. The UAV 220 may be configured to function as a base station, or more specifically as a mobile base station. That is, in some examples, a cell may not necessarily be stationary, and the geographic area of the cell may move according to the location of a mobile base station, such as the UAV 220.

Within the RAN 200, the cells may include UEs that may be in communication with one or more sectors of each cell. Further, each base station 210, 212, 214, 218, and 220 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; UE 234 may be in communication with base station 218; and UE 236 may be in communication with mobile base station 220. In some examples, the UEs 222, 224, 226, 228, 230, 232, 234, 236, 238, 240, and/or 242 may be the same as or similar to the UE/scheduled entity 106 described above and illustrated in FIG. 1. In some examples, the UAV 220 (e.g., the quadcopter) can be a mobile network node and may be configured to function as a UE. For example, the UAV 220 may operate within cell 202 by communicating with base station 210.

In a further aspect of the RAN 200, sidelink signals may be used between UEs without necessarily relying on scheduling or control information from a base station. Sidelink communication may be utilized, for example, in a device-to-device (D2D) network, peer-to-peer (P2P) network, vehicle-to-vehicle (V2V) network, vehicle-to-everything (V2X) network, and/or other suitable sidelink network. For example, two or more UEs (e.g., UEs 238, 240, and 242) may communicate with each other using sidelink signals 237 without relaying that communication through a base station. In some examples, the UEs 238, 240, and 242 may each function as a scheduling entity or transmitting sidelink device and/or a scheduled entity or a receiving sidelink device to schedule resources and communicate sidelink signals 237 therebetween without relying on scheduling or control information from a base station. In other examples, two or more UEs (e.g., UEs 226 and 228) within the coverage area of a base station (e.g., base station 212) may also communicate sidelink signals 227 over a direct link (sidelink) without conveying that communication through the base station 212. In this example, the base station 212 may allocate resources to the UEs 226 and 228 for the sidelink communication.

In some examples, a D2D relay framework may be included within a cellular network to facilitate relaying of communication to/from the base station 212 via D2D links (e.g., sidelinks 227 or 237). For example, one or more UEs (e.g., UE 228) within the coverage area of the base station 212 may operate as relaying UEs to extend the coverage of the base station 212, improve the transmission reliability to one or more UEs (e.g., UE 226), and/or to allow the base station to recover from a failed UE link due to, for example, blockage or fading.

In order for transmissions over the air interface to obtain a low block error rate (BLER) while still achieving very high data rates, channel coding may be used. That is, wireless communication may generally utilize a suitable error correcting block code. In a typical block code, an information message or sequence is split up into code blocks (CBs), and an encoder (e.g., a CODEC) at the transmitting device then mathematically adds redundancy to the information message. Exploitation of this redundancy in the encoded information message can improve the reliability of the message, enabling correction for any bit errors that may occur due to the noise.

Data coding may be implemented in multiple manners. In early 5G NR specifications, user data is coded using quasi-cyclic low-density parity check (LDPC) with two different base graphs: one base graph is used for large code blocks and/or high code rates, while the other base graph is used otherwise. Control information and the physical broadcast channel (PBCH) are coded using Polar coding, based on nested sequences. For these channels, puncturing, shortening, and repetition are used for rate matching.

Aspects of the present disclosure may be implemented utilizing any suitable channel code. Various implementations of base stations and UEs may include suitable hardware and capabilities (e.g., an encoder, a decoder, and/or a CODEC) to utilize one or more of these channel codes for wireless communication.

In the RAN 200, the ability of UEs to communicate while moving, independent of their location, is referred to as mobility. The various physical channels between the UE and the RAN 200 are generally set up, maintained, and released under the control of an access and mobility management function (AMF). In some scenarios, the AMF may include a security context management function (SCMF) and a security anchor function (SEAF) that performs authentication. The SCMF can manage, in whole or in part, the security context for both the control plane and the user plane functionality.

In various aspects of the disclosure, the RAN 200 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, the UE 224 may move from the geographic area corresponding to its serving cell 202 to the geographic area corresponding to a neighbor cell 206. When the signal strength or quality from the neighbor cell 206 exceeds that of its serving cell 202 for a given amount of time, the UE 224 may transmit a reporting message to its serving base station 210 indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCHs)). The UEs 222, 224, 226, 228, 230, and 232 may receive the unified synchronization signals, derive the carrier frequency, and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the RAN 200. Each of the cells may measure a strength of the pilot signal, and the radio access network (e.g., one or more of the base stations 210 and 214/216 and/or a central node within the core network) may determine a serving cell for the UE 224. As the UE 224 moves through the RAN 200, the RAN 200 may continue to monitor the uplink pilot signal transmitted by the UE 224. When the signal strength or quality of the pilot signal measured by a neighboring cell exceeds that of the signal strength or quality measured by the serving cell, the RAN 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the radio access network 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple radio access technologies (RATs). For example, the holder of a license for a portion of licensed spectrum may provide licensed shared access (LSA) to share that spectrum with other parties, e.g., with suitable licensee-determined conditions to gain access.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4-a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

Devices communicating in the radio access network 200 may utilize one or more multiplexing techniques and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Devices in the radio access network 200 may also utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, in some scenarios, a channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to herein as sub-band full duplex (SBFD), also known as flexible duplex.

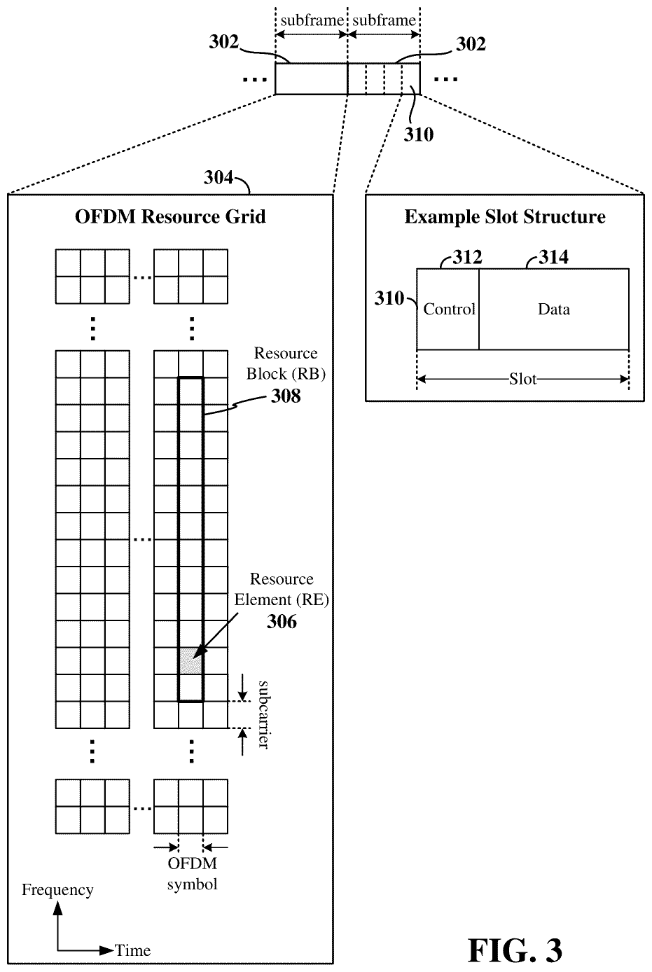

Various aspects of the present disclosure will be described with reference to an orthogonal frequency division multiplexing (OFDM) waveform, schematically illustrated in FIG. 3. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 3, an expanded view of an exemplary subframe 302 is illustrated, showing an OFDM resource grid. However, as those skilled in the art will readily appreciate, the physical (PHY) transmission structure for any particular application may vary from the example described here, depending on any number of factors. Here, time is in the horizontal direction with units of OFDM symbols; and frequency is in the vertical direction with units of subcarriers of the carrier.

The resource grid 304 may be used to schematically represent time-frequency resources for a given antenna port. That is, in a multiple-input-multiple-output (MIMO) implementation with multiple antenna ports available, a corresponding multiple number of resource grids 304 may be available for communication. The resource grid 304 is divided into multiple resource elements (REs) 306. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 308, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 308 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of scheduled entities (e.g., UEs) for downlink, uplink, or sidelink transmissions involves scheduling one or more resource elements 306 within one or more sub-bands or bandwidth parts (BWPs). Thus, a UE generally utilizes only a subset of the resource grid 304. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a base station (e.g., gNB, eNB, etc.), or may be self-scheduled by a UE implementing D2D sidelink communication.

In this illustration, the RB 308 is shown as occupying less than the entire bandwidth of the subframe 302, with some subcarriers illustrated above and below the RB 308. In a given implementation, the subframe 302 may have a bandwidth corresponding to any number of one or more RBs 308. Further, in this illustration, the RB 308 is shown as occupying less than the entire duration of the subframe 302, although this is merely one possible example.

Each 1 ms subframe 302 may consist of one or multiple adjacent slots. In the example shown in FIG. 3, one subframe 302 includes four slots 310, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 310 illustrates the slot 310 including a control region 312 and a data region 314. In general, the control region 312 may carry control channels, and the data region 314 may carry data channels. Of course, a slot may contain all DL, all UL, or at least one DL portion and at least one UL portion. The structure illustrated in FIG. 3 is merely exemplary in nature, and different slot structures may be utilized, and may include one or more of each of the control region(s) and data region(s).

Although not illustrated in FIG. 3, the various REs 306 within an RB 308 may be scheduled to carry one or more physical channels, including control channels, shared channels, data channels, etc. Other REs 306 within the RB 308 may also carry pilots or reference signals. These pilots or reference signals may provide for a receiving device to perform channel estimation of the corresponding channel, which may enable coherent demodulation/detection of the control and/or data channels within the RB 308.

In some examples, the slot 310 may be utilized for broadcast, multicast, groupcast, or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast or groupcast communication is delivered to multiple intended recipient devices. A unicast communication may refer to a point-to-point transmission by a one device to a single other device.

In an example of cellular communication over a cellular carrier via a Uu interface, for a DL transmission, the scheduling entity (e.g., a base station) may allocate one or more REs 306 (e.g., within the control region 312) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry hybrid automatic repeat request (HARQ) feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The base station may further allocate one or more REs 306 (e.g., in the control region 312 or the data region 314) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 40, 80, or 160 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType1 (SIB1) that may include various additional system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESET0), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A base station may transmit other system information (OSI) as well.

In an UL transmission, the scheduled entity (e.g., UE) may utilize one or more REs 306 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 306 (e.g., within the data region 314) may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 306 within the data region 314 may be configured to carry other signals, such as one or more SIBs and DMRSs.

In an example of sidelink communication over a sidelink carrier via a proximity service (ProSe) PC5 interface, the control region 312 of the slot 310 may include a physical sidelink control channel (PSCCH) including sidelink control information (SCI) transmitted by an initiating (transmitting) sidelink device (e.g., Tx V2X device or other Tx UE) towards a set of one or more other receiving sidelink devices (e.g., Rx V2X device or other Rx UE). The data region 314 of the slot 310 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 306 within slot 310. For example, HARQ feedback information may be transmitted in a physical sidelink feedback channel (PSFCH) within the slot 310 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 310.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers illustrated in FIGS. 1-3 are not necessarily all of the channels or carriers that may be utilized between devices, and those of ordinary skill in the art will recognize that other channels or carriers may be utilized in addition to those illustrated, such as other traffic, control, and feedback channels.

Transmissions of data traffic from the network entity to a UE may occur within downlink OFDM symbols of subframes or slots. The network entity may indicate to a UE that the network entity has data to transmit to the UE by transmitting scheduling information providing time-frequency resources (e.g., REs) allocated by the network entity for the transmission of the data to the UE. The scheduling information may be included, for example, within DCI of a PDCCH transmitted at the beginning of a subframe or slot. The UE may monitor the PDCCHs in each subframe or slot to determine whether a downlink data transmission has been scheduled for the UE. However, since a UE may not receive data in every subframe or slot, the PDCCH monitoring process may lead to high battery consumption.

To reduce power consumption and extend battery life, a wireless communication device (e.g., a UE) may enter a discontinuous reception (DRX) mode. The DRX mode allows the wireless communication device to enter a sleep state (e.g., a low-power state) for a period of time. The UE may then periodically wake-up (e.g., perform a power-up operation) to communicate with the network entity. The periodic repetition of cycling between sleep states and active states is referred to herein as DRX. DRX may be implemented by any type of UE, but may be a preferred mode for machine-type communication (MTC) devices, such as Narrowband Internet of Things (NB-IoT) devices, or other type of reduced-capability devices.

A UE may enter the DRX mode in a radio resource control (RRC) connected state (connected mode DRX (C-DRX)) or an RRC idle state (idle mode DRX (I-DRX)). The network entity may configure various parameters for I-DRX mode and C-DRX mode and provide the DRX parameters to the UE through an upper layer RRC reconfiguration message (e.g., during handover) or via one or more SIBs (e.g., during initial attach).

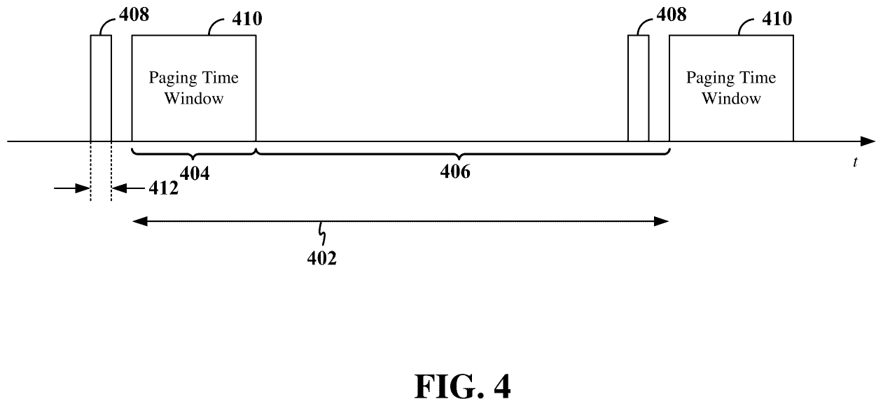

FIG. 4 is a diagram illustrating an example of idle mode discontinuous reception (I-DRX) according to some aspects. A wireless communication device (e.g., a UE) may enter the I-DRX mode during RRC idle mode when the UE is not connected to the network entity. For example, during initial cell access, the UE may receive a SIB (e.g., SIB2) including DRX parameters for the I-DRX mode. The UE may then transition to the RRC idle state and enter I-DRX mode for power savings.

The DRX idle mode (I-DRX) is characterized by a number of consecutive DRX cycles 402 in time (t). The duration of each DRX cycle 402 may correspond, for example, to a paging cycle set by the network. For example, the paging cycle may be defined in terms of radio frames and the UE may calculate the paging frames and paging occasions within the paging frames for the UE based on the paging cycle. Here, a paging frame corresponds to a radio frame in which the UE may wake-up to receive a page. In addition, a paging occasion corresponds to a subframe where a paging message intended for the UE may be received. In one DRX cycle 402, there is only one paging occasion for each UE.

In the example shown in FIG. 4, each DRX cycle 402 includes a DRX ON duration 404 and a DRX OFF duration 406. Here, the DRX cycle length (or DRX cycle duration) is equal to the time between the start of one DRX ON duration 404 and the start of the next DRX ON duration 404. The DRX OFF duration 406 corresponds to a period of inactivity where the wireless communication device does not communicate with the wireless communication network. Thus, during the DRX OFF duration 406, the wireless communication device may enter a sleep state or low-power state for a sleep period corresponding to the DRX OFF duration 406 to reduce power consumption. In some examples, the DRX OFF duration 406 may be 320 ms, 640 ms, 1280 ms, or 2560 ms.

Upon entering the DRX ON duration 404, the wireless communication device wakes-up by performing a power-up operation to enter an active state. The DRX ON duration 404 may include a paging time window 410 containing a paging occasion within which the wireless communication device may receive a paging message. For example, each paging time window 410 may follow a normal paging cycle (e.g., 1.28 seconds) utilized in the wireless communication network. If the wireless communication device receives a page during the paging time window 410, the wireless communication device may transition to an RRC connected state to receive a downlink data transmission from the network entity and then re-transition back to an RRC idle state after receipt of the downlink data transmission. At the end of the paging time window 410 or upon transitioning back to the RRC idle state, the wireless communication device may again enter a sleep state or low-power state for the DRX OFF duration 406.

Prior to each paging time window 410 (e.g., prior to the subframe number (SFN) of the paging occasion at which the wireless communication device wakes up), the wireless communication device may schedule and perform one or more tracking loop updates 408 during a warm-up occasion 412. For example, the wireless communication device may perform a time tracking loop (TTL) update, frequency tracking loop (FTL) update, power delay profile (PDP) estimation update, and/or automatic gain control (AGC) update procedure during the warm-up occasion 412. For example, by implementing a TTL, the wireless communication device may be able to correct the timing error and optimize the starting point of the fast Fourier transform (FFT) window to minimize inter-symbol interference (ISI). FTLs may enable the wireless communication device to correct the carrier frequency offset due to RF impairments at both the wireless communication device and the network entity and may further enable the wireless communication device to correct the Doppler shift due to mobility of the wireless communication device. In addition, the wireless communication device may perform a PDP estimation to compensate for dispersion or distribution of power over various paths due to multi-path propagation. The wireless communication device may further perform various AGC procedures to control the level or gain of the received signal in order to minimize the block error rate (BLER) of the received signal.

In some examples, the wireless communication device may receive a reference signal, such as a channel state information-reference signal (CSI-RS) or a synchronization signal block (SSB), transmitted by the network entity for tracking loop updates. The SSB may be transmitted within a cell with known periodicity (e.g., 20 ms). Therefore, in some examples, the warm-up occasion 412 may occur at the known SSB transmission time prior to the wake-up time for the paging time window 410.

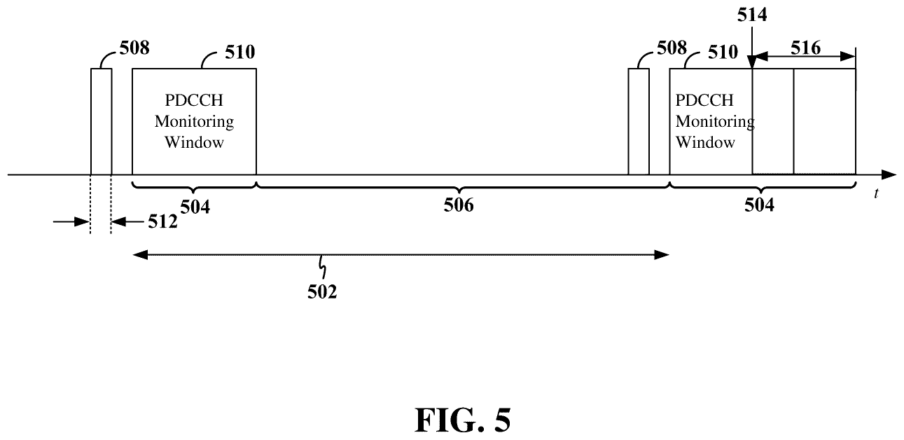

FIG. 5 is a diagram illustrating an example of connected mode discontinuous reception (C-DRX) according to some aspects. A wireless communication device (e.g., a UE) may enter the C-DRX mode during RRC connected mode when the UE is connected to the network entity. For example, during initial cell access, the UE may receive a SIB (e.g., SIB2) including DRX parameters for the C-DRX mode. In some examples, the UE may request a DRX cycle length during the initial attach procedure.

The DRX connected mode (C-DRX) is characterized by a number of consecutive DRX cycles 502 in time (t). The duration of each DRX cycle 502 may correspond, for example, to a long DRX cycle or a short DRX cycle, depending on the C-DRX configuration. In the example shown in FIG. 5, each DRX cycle 402 includes a DRX ON duration 504 and a DRX OFF duration 506. Here, the DRX cycle length (or DRX cycle duration) is equal to the time between the start of one DRX ON duration 504 and the start of the next DRX ON duration 504. The DRX OFF duration 506 corresponds to a period of inactivity where the wireless communication device does not communicate with the wireless communication network (e.g., the wireless communication device does not transmit any information to or receive any information from the wireless communication network). Thus, during the DRX OFF duration 506, the wireless communication device may enter a sleep state or low-power state for a sleep period corresponding to the DRX OFF duration 506 to reduce power consumption. In some examples, the DRX OFF duration 506 may be 40 ms, 80 ms, 160 ms, or 320 ms.

Upon entering the DRX ON duration 504, the wireless communication device wakes-up by performing a power-up operation to enter an active state. The DRX ON duration 504 may include a PDCCH monitoring window 510 within which the wireless communication device monitors for the transmission of a PDCCH from the network entity to the wireless communication device. If the wireless communication device receives a PDCCH 514 during a PDCCH monitoring window 510, the wireless communication device may initiate a DRX-Inactivity timer 516, which specifies the duration of time that the wireless communication device should remain in the active state after receiving a PDCCH 514. In some examples, depending on when the PDCCH 514 is received during the PDCCH monitoring window 510, the DRX-Inactivity timer 516 may extend the DRX ON duration 504, as shown in FIG. 5. At the end of the DRX ON duration 504, the wireless communication device may again enter a sleep state or low-power state for the DRX OFF duration 506.

Prior to each PDCCH monitoring window 510 (e.g., prior to the subframe number (SFN) of the subframe at which the wireless communication device is configured to wake up), the wireless communication device may schedule and perform one or more tracking loop updates 508 during a warm-up occasion 512. For example, the wireless communication device may perform a TTL update, FTL update, PDP estimation update, and/or AGC update procedure during the warm-up occasion 512, as described above. In some examples, the wireless communication device may receive a reference signal, such as a channel state information-reference signal (CSI-RS) or a synchronization signal block (SSB), transmitted by the network entity for tracking loop updates. The SSB may be transmitted within a cell with known periodicity (e.g., 20 ms). Therefore, in some examples, the warm-up occasion 512 may occur at the known SSB transmission time prior to the wake-up time for the DRX ON duration 504. In some examples, the SSB transmission time may occur after the DRX ON duration 504. In this example, the UE may wake-up during a warm-up occasion after the DRX ON occasion 504 to perform one or more updates.

Wireless communication networks, such as 4G LTE and/or 5G NR networks, may further support carrier aggregation in a multi-cell transmission environment where, for example, different network entities and/or different transmission and reception points (TRPs) may communicate on different component carriers within overlapping cells. In some aspects, the term component carrier may refer to a carrier frequency utilized for communication within a cell.

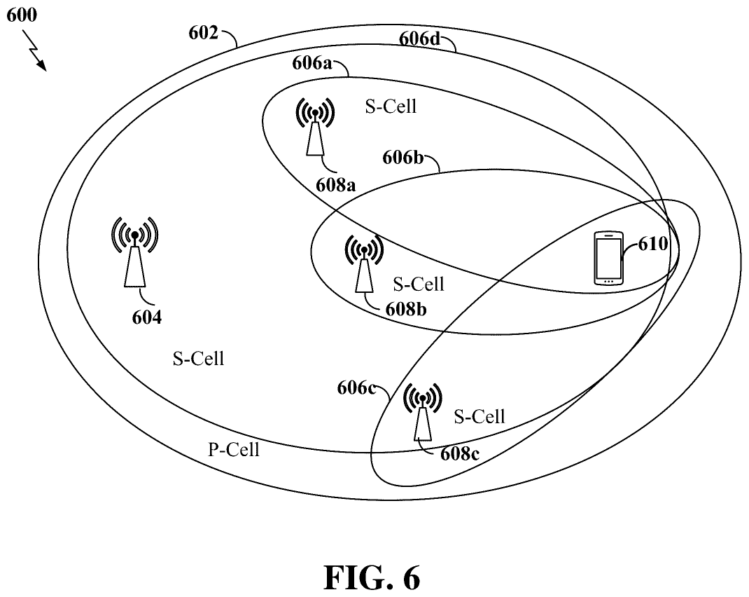

FIG. 6 is a diagram illustrating a multi-cell transmission environment 600 according to some aspects. The multi-cell transmission environment 600 includes a primary serving cell (PCell) 602 and one or more secondary serving cells (SCells) 606a, 606b, 606c, and 606d. The PCell 602 may be referred to as the anchor cell that provides a radio resource control (RRC) connection to a UE (e.g., UE 610).

When carrier aggregation is configured in the multi-cell transmission environment 600, one or more of the SCells 606a-606d may be activated or added to the PCell 602 to form the serving cells serving the UE 610. In this case, each of the serving cells corresponds to a component carrier (CC). The CC of the PCell 602 may be referred to as a primary CC, and the CC of a SCell 606a-606d may be referred to as a secondary CC.

Each of the PCell 602 and the SCells 606a-606d may be served by a transmission and reception point (TRP). For example, the PCell 602 may be served by TRP 604 and each of the SCells 606a-606c may be served by a respective TRP 608a-608c. Each TRP 604 and 608a-608c may be a base station (e.g., aggregated base station), remote radio head of a gNB, a radio unit (RU) of disaggregated RAN architecture, or other scheduling entity similar to those illustrated in any of FIGS. 1, 2, and/or 4. In some examples, the PCell 602 and one or more of the SCells (e.g., SCell 606d) may be co-located. For example, a TRP for the PCell 602 and a TRP for the SCell 606d may be installed at the same geographic location. Thus, in some examples, a TRP (e.g., TRP 604) may include multiple TRPs, each corresponding to one of a plurality of co-located antenna arrays, and each supporting a different carrier (different CC). However, the coverage of the PCell 602 and SCell 606d may differ since different component carriers may experience different path loss, and thus provide different coverage.

The PCell 602 is responsible not only for connection setup, but also for radio resource management (RRM) and radio link monitoring (RLM) of the connection with the UE 610. For example, the PCell 602 may activate one or more of the SCells (e.g., SCell 606a) for multi-cell communication with the UE 610 to improve the reliability of the connection to the UE 610 and/or to increase the data rate. In some examples, the PCell may activate the SCell 606a on an as-needed basis instead of maintaining the SCell activation when the SCell 606a is not utilized for data transmission/reception in order to reduce power consumption by the UE 610.

In some examples, the PCell 602 may be utilize a first radio access technology (RAT), while one or more of the SCells 606 may utilize a second RAT. For example, the PCell 602 may use a first RAT associated with a first frequency range (e.g., sub-6 GHZ band or FR1), while an SCell (e.g., SCell 606d) may use a second RAT associated with a second frequency range (e.g., FR2 or higher). Thus, the PCell 602 may be a low band cell, and one or more of the SCells 606 may be high band cells. Here, the low band (LB) cell uses a CC in a frequency band lower than that of the high band cells. In general, a cell using an FR2 or higher CC can provide greater bandwidth than a cell using an FR1 CC. In addition, when using above-6 GHz frequency (e.g., mmWave) carriers, beamforming may be used to transmit and receive signals.

In some examples, the first RAT may be LTE, while the second RAT may be 5G-NR. In this example, the multi-cell transmission environment may be referred to as a multi-RAT-dual connectivity (MR-DC) environment. One example of MR-DC is an Evolved-Universal Terrestrial Radio Access Network-New Radio dual connectivity (EN-DC) mode that enables a UE to simultaneously connect to an LTE base station and a NR base station to receive data packets from and send data packets to both the LTE base station and the NR base station.

In some examples, instead of aggregating multiple carriers, a UE may be configured with both an uplink carrier and a supplementary uplink (SUL) carrier. The SUL carrier may be, for example, at a lower frequency to provide higher data rates with lower path loss.

In NR, with a mixed carrier aggregation (CA) configuration where the primary component carrier (PCC) of the PCell and the secondary component carrier (SCC) of the SCell belong to different RATs associated with different frequency ranges (e.g., FR1 and FR2), each of the RATs (e.g., each of the PCell and the SCell) may implement different wake-up timing while the UE is in DRX mode. As described above, the UE may wake-up during a warm-up occasion (e.g., an SSB occasion) prior to or after a CDRX ON duration to perform TTL/FTL updates in order to ensure good device performance. For example, the UE may wake-up at least 5-20 ms in advance of the ON duration to ensure the TTL/FTL drifts are minimal during data activity.

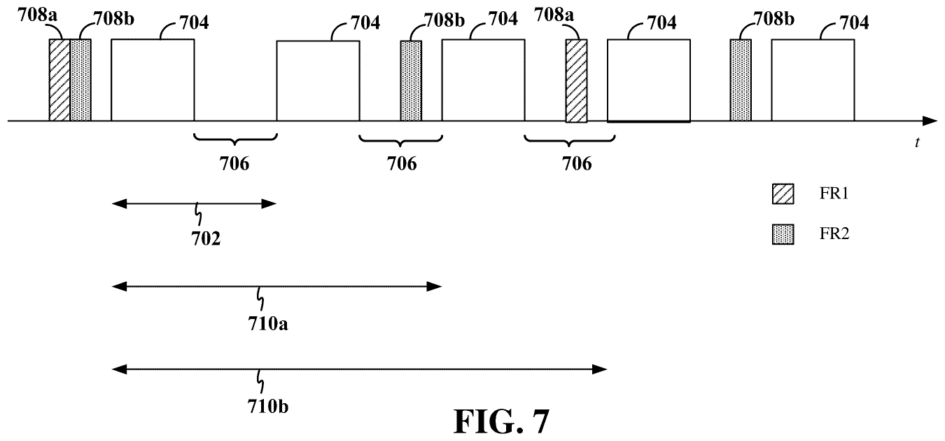

FIG. 7 is a diagram illustrating an example of mixed CA DRX wake-up and warm-up according to some aspects. In the example shown in FIG. 7, a C-DRX mode is illustrated that is characterized by a number of consecutive DRX cycles 702 in time (t). The duration of each DRX cycle 702 may correspond, for example, to a long DRX cycle or a short DRX cycle, depending on the C-DRX configuration. In the example shown in FIG. 7, each DRX cycle 702 includes a DRX ON duration 704 and a DRX OFF duration 706. Here, the DRX cycle length (or DRX cycle duration) is equal to the time between the start of one DRX ON duration 704 and the start of the next DRX ON duration 704. The DRX OFF duration 706 corresponds to a period of inactivity where the UE does not communicate with the wireless communication network (e.g., the UE does not transmit any information to or receive any information from the wireless communication network). Thus, during the DRX OFF duration 706, the UE may enter a sleep state or low-power state for a sleep period corresponding to the DRX OFF duration 706 to reduce power consumption. In some examples, the DRX OFF duration 706 may be 40 ms, 80 ms, 160 ms, or 320 ms.

In the example shown in FIG. 7, the UE is communicating in a mixed CA mode using a first RAT associated with a frequency range (e.g., FR1) to communicate with a first cell (e.g., a PCell) and a second RAT associated with a second frequency range (e.g., FR2) to communicate with a second cell (e.g., an SCell). Prior to one or more of the DRX ON durations 704, the UE may schedule and perform one or more tracking loop updates for each of the RATs (e.g., for FR1 and FR2) during respective warm-up occasions 708a and 708b. For example, the wireless communication device may perform a TTL update, FTL update, PDP estimation update, and/or AGC update procedure during the warm-up occasions 708a and 708b, as described above. In some examples, the wireless communication device may receive a reference signal, such as a channel state information—reference signal (CSI-RS) or a synchronization signal block (SSB), transmitted by the network entity for tracking loop updates. The SSB may be transmitted within a cell with known periodicity (e.g., 20 ms). Therefore, in some examples, the warm-up occasions 708a and 708b may occur at the known SSB transmission time prior to the wake-up time for the DRX ON duration 704. In some examples, the SSB transmission time may occur after the DRX ON duration 704. In this example, the UE may wake-up during a warm-up occasion after the DRX ON duration 704 to perform one or more updates.

In some examples, the warm-up occasions 708a and 708b to perform tracking loop updates may differ between FR1 and FR2 based on, for example, the periodicity of SSB transmissions in each of the RATs or other suitable factors. Thus, each RAT may have a respective different wake-up periodicity to perform tracking loop updates. For example, as shown in FIG. 7, FR2 warm-up 708b may occur every two DRX cycles 710a (e.g., FR2 has a wake-up periodicity of two DRX cycles), while FR1 warm-up 708a may occur every three DRX cycles (e.g., FR1 has a wake-up periodicity of three DRX cycles). Therefore, as shown in FIG. 7, the UE may perform a warm-up 708b for FR2 in every second, fourth, sixth, etc., DRX cycle, and perform a warm-up 708a for FR1 in every third, sixth, ninth, etc., DRX cycle. Based on this configuration, the UE may perform a warm-up 708a or 708b in seven out of ten (7/10) DRX cycles 702. Each time the UE performs a warm-up, the UE consumes a significant amount of power for beamforming (to receive the SSB beams in FR1 and FR2) and for completing the tracking loop updates. Due to the different warm-up occasions 708a and 708b for FR1 (sub-6) and FR2 (mmWave), the UE may wake-up almost twice as often in mixed CA scenarios to perform warm-ups than in non-mixed CA scenarios, which increases the power consumption by the UE.

The UE may be capable of performing simultaneous warm-up 708a/708b in both FR1 and FR2 (e.g., as shown prior to the first DRX cycle in FIG. 7). However, due to the different periodicities of FR1 and FR2 warm-up 708a/708b, the UE may have to wait to perform a warm-up 708a for one of the RATs (e.g., FR1) even though the UE is scheduled for warm-up 708b on the other RAT (e.g., FR2) in a particular DRX cycle 702, which results in a power wastage at the UE as a result of the multiple warm-up occasions.

Therefore, various aspects are directed to techniques to modifying warm-up occasions of one or both RATs (e.g., FR1 and/or FR2) to provide joint warm-up occasions during a same DRX cycle for both FR1 and FR2. By performing joint warm-ups of FR1 and FR2 in the same DRX cycle instead of performing warm-ups for FR1 and FR2 in different DRX cycles, power consumption by the UE may be reduced, thus improving battery life.

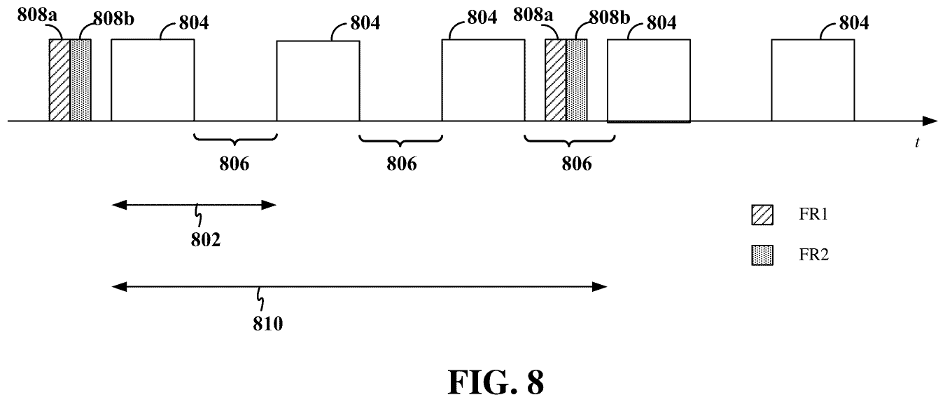

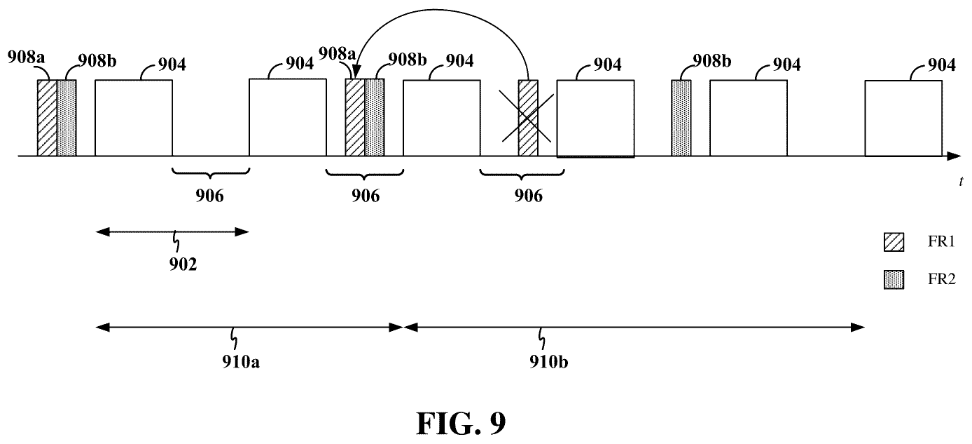

FIG. 8 is a diagram illustrating an example of reduced warm-up occasions in DRX mode for mixed CA scenarios according to some aspects. In the example shown in FIG. 8, a C-DRX mode is again illustrated that is characterized by a number of consecutive DRX cycles 802 in time (t). The duration of each DRX cycle 802 may correspond, for example, to a long DRX cycle or a short DRX cycle, depending on the C-DRX configuration. In the example shown in FIG. 8, each DRX cycle 802 includes a DRX ON duration 804 and a DRX OFF duration 806. Here, the DRX cycle length (or DRX cycle duration) is equal to the time between the start of one DRX ON duration 804 and the start of the next DRX ON duration 804. The DRX OFF duration 806 corresponds to a period of inactivity where the UE does not communicate with the wireless communication network (e.g., the UE does not transmit any information to or receive any information from the wireless communication network). Thus, during the DRX OFF duration 806, the UE may enter a sleep state or low-power state for a sleep period corresponding to the DRX OFF duration 806 to reduce power consumption. In some examples, the DRX OFF duration 806 may be 40 ms, 80 ms, 160 ms, or 320 ms.

In the example shown in FIG. 8, the UE is again communicating in a mixed CA mode using a first RAT associated with a frequency range (e.g., FR1) to communicate with a first cell (e.g., a PCell) and a second RAT associated with a second frequency range (e.g., FR2) to communicate with a second cell (e.g., an SCell). Each RAT may have a respective wake-up periodicity associated therewith to perform tracking look updates while the UE is in DRX mode, for example, as shown in FIG. 7.

In some aspects, as shown in FIG. 8, upon detecting that the UE is operating in a mixed CA mode, the UE may be configured to derive a generic (joint) wake-up periodicity 810 to perform a respective warm-up 708a and 708b on each of the RATs (e.g., FR1 and FR2) during the same DRX cycle (e.g., substantially simultaneously immediately prior to or immediately after the DRX ON duration 704 of the DRX cycle). For example, the UE can identify a first wake-up periodicity of a first RAT (e.g., FR1) and a second wake-up periodicity of a second RAT (e.g., FR2), similar to the wake-up periodicities 710a, 710b shown in FIG. 7. The UE may then identify a joint wake-up periodicity 810 for both the first RAT and the second RAT. The UE may then perform joint warm-ups 808a/808b for the RATs (e.g., FR1 and FR2) based on the joint wake-up periodicity 810. Each joint warm-up 808a/808b may occur during a same DRX cycle 802. For example, as shown in FIG. 8, the joint wake-up periodicity is three DRX cycles. As such, a joint warm-up occasion 808a/808b may occur prior to every third, sixth, ninth, etc., DRX cycles.

The joint wake-up periodicity 810 may correspond, for example, to any value between the first wake-up periodicity of the first RAT (e.g., FR1) and the second wake-up periodicity of the second RAT (e.g., FR2). For example, the joint wake-up periodicity may be between [FR1_WU, FR2_WU]. In some examples, the joint wake-up periodicity 810 may correspond to an average of the first wake-up periodicity of the first RAT (e.g., FR1) and the second wake-up periodicity of the second RAT (e.g., FR2). For example, the joint wake-up periodicity may be calculated as: (FR1_WU+FR2_WU)/2. In other examples, the joint wake-up periodicity 810 may correspond to the maximum wake-up periodicity (e.g., max (FR1_WU, FR2_WU)) or the minimum wake-up periodicity (e.g., min (FR1_WU, FR2_WU)).

In some examples, the joint wake-up periodicity 810 may be dynamically modified (e.g., changed) based on, for example, channel conditions of at least one of FR1 and FR2. For example, if the FR2 channel conditions decline (e.g., signal strength of FR2 becomes weak or drops below a threshold), the joint wake-up periodicity 810 may be decreased and brought closer to the FR2 wake-up periodicity, and vice-versa. In this example, the joint wake-up periodicity 810 may be reduced from three DRX cycles to two DRX cycles. As another example, if the channel conditions of both FR1 and FR2 are good (e.g., above a threshold), the joint wake-up periodicity 810 can set to the maximum joint periodicity (e.g., three DRX cycles). In this example, the number of warm-up occasions can be reduced, as compared to FIG. 7, to four out of ten (4/10) DRX cycles. As yet another example, if the UE is mid or cell-edge for one of FR1 or FR2, the joint wake-up periodicity 810 can be set to the minimum joint periodicity (e.g., two DRX cycles). In this example, the number of warm-up occasions can be reduced, as compared to FIG. 7, to five out of ten (5/10) DRX cycles. By reducing the number of warm-up occasions and providing joint warm-up occasions, the UE may not only reduce power, but also improve UE performance.

FIG. 9 is a diagram illustrating an example of reduced warm-up occasions in DRX mode for mixed CA scenarios according to some aspects. In the example shown in FIG. 9, a C-DRX mode is again illustrated that is characterized by a number of consecutive DRX cycles 902 in time (t). The duration of each DRX cycle 902 may correspond, for example, to a long DRX cycle or a short DRX cycle, depending on the C-DRX configuration. In the example shown in FIG. 9, each DRX cycle 902 includes a DRX ON duration 904 and a DRX OFF duration 906. Here, the DRX cycle length (or DRX cycle duration) is equal to the time between the start of one DRX ON duration 904 and the start of the next DRX ON duration 904. The DRX OFF duration 906 corresponds to a period of inactivity where the UE does not communicate with the wireless communication network (e.g., the UE does not transmit any information to or receive any information from the wireless communication network). Thus, during the DRX OFF duration 906, the UE may enter a sleep state or low-power state for a sleep period corresponding to the DRX OFF duration 906 to reduce power consumption. In some examples, the DRX OFF duration 906 may be 40 ms, 90 ms, 160 ms, or 320 ms.

In the example shown in FIG. 9, the UE is again communicating in a mixed CA mode using a first RAT associated with a frequency range (e.g., FR1) to communicate with a first cell (e.g., a PCell) and a second RAT associated with a second frequency range (e.g., FR2) to communicate with a second cell (e.g., an SCell). Each RAT may have a respective wake-up periodicity associated therewith to perform tracking look updates while the UE is in DRX mode, for example, as shown in FIG. 7.

In some aspects, as shown in FIG. 9, the UE may detect that the UE is scheduled to perform a warm-up (e.g., warm-up 908a or 908b) for only one of the RATs (e.g., FR1 or FR2) during a DRX cycle. For example, prior to the third DRX cycle 902 shown in FIG. 9, the UE may detect that the UE is scheduled to perform a warm-up 908b for only FR2. Prior to the warm-up occasion 908b for FR2 before the third DRX cycle, the UE may perform an evaluation of one or more key performance indicators (KPIs) related to FR1. For example, the UE may evaluate various channel conditions, such as the reference signal received power (RSRP), reference signal received quality (RSRQ), signal-to-interference-plus-noise ratio (SINR), time drifts, frequency drifts, beam rotation, sensor inputs (e.g., indicating that the UE is moving) or other suitable KPIs. The evaluation may be based on, for example, measurements obtained during the previous DRX ON duration.

Based on the evaluation, the UE may be configured to modify the next warm-up occasion 908a for FR1 to occur within the same DRX cycle (e.g., prior to the third DRX cycle) as the current warm-up occasion 908b for FR2. Thus, the UE may modify the wake-up periodicity of FR1 to equal that of FR2 (e.g., wake-up periodicity 910a) to provide a joint warm-up occasion 908a/908b for both the first RAT (e.g., FR1) and the second RAT (e.g., FR2) based on the KPI evaluation related to the first RAT.

The UE may further skip one or more next scheduled warm-up occasions 908a for FR1 within the next K DRX cycles based on the wake-up periodicity 910b of FR1, as can be seen in FIG. 9. Here, K is equal to the wake-up periodicity for FR1 (FR1_WU). Thus, the UE may skip any warm-up occasions 908a for FR1 scheduled during the next K number of DRX cycles equal to the wake-up periodicity 908a of FR1. It should be noted that if the UE were to modify the wake-up periodicity of FR2 based on an evaluation thereof to match that of FR1, K would be equal to the wake-up periodicity of FR2 (FR2_WU). In the example shown in FIG. 9, the number of warm-up occasions can be reduced, as compared to FIG. 7, to five out of ten (5/10) DRX cycles. By modifying the warm-up occasion of one of the RATs to provide a joint warm-up occasion 908a/908b for both RATs and skipping the next scheduled warm-up occasion(s) for the modified RAT, the UE may not only save power, but also improve UE performance (e.g., by performing an early warm-up on FR1).

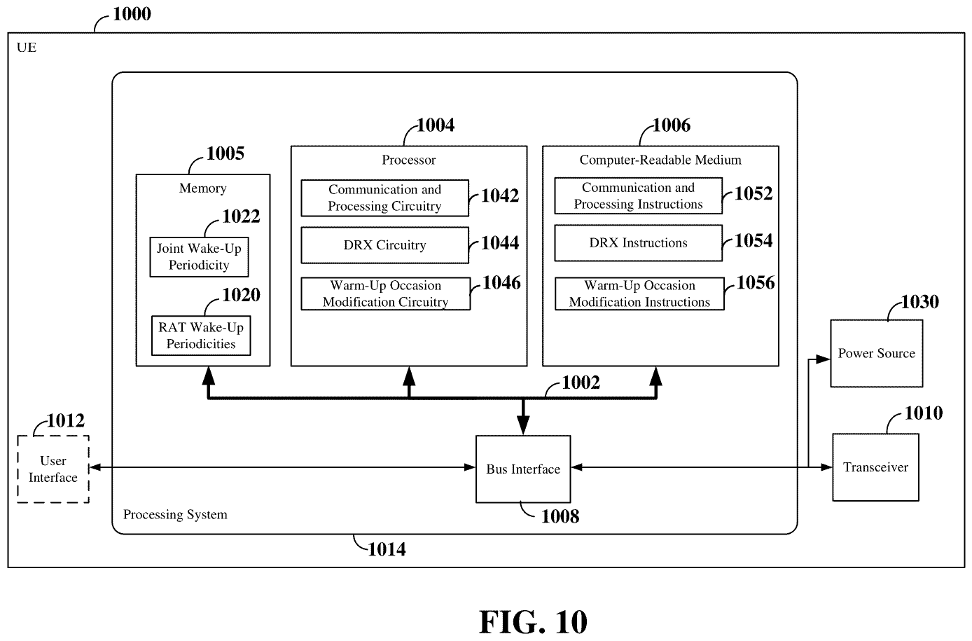

FIG. 10 is a conceptual diagram illustrating an example of a hardware implementation for an exemplary UE 1000 employing a processing system 1014. For example, the UE 1000 may be any of the UEs or other scheduled entities as illustrated in any one or more of FIGS. 1, 2, and/or 6.

The UE 1000 may be implemented with a processing system 1014 that includes one or more processors 1004. Examples of processors 1004 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the UE 1000 may be configured to perform any one or more of the functions described herein. That is, the processor 1004, as utilized in a UE 1000, may be used to implement any one or more of the processes described below in connection with FIG. 10.

The processor 1004 may in some instances be implemented via a baseband or modem chip and in other implementations, the processor 1004 may itself comprise a number of devices distinct and different from a baseband or modem chip (e.g., in such scenarios as may work in concert to achieve examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 1014 may be implemented with a bus architecture, represented generally by the bus 1002. The bus 1002 may include any number of interconnecting buses and bridges depending on the specific application of the processing system 1014 and the overall design constraints. The bus 1002 communicatively couples together various circuits including one or more processors (represented generally by the processor 1004), a memory 1005, and computer-readable media (represented generally by the computer-readable medium 1006). The bus 1002 may also link various other circuits such as timing sources, peripherals, voltage regulators, and power management circuits, which are well known in the art, and therefore, will not be described any further. A bus interface 1008 provides an interface between the bus 1002 and a transceiver 1010. The transceiver 1010 provides a means for communicating with various other apparatus over a transmission medium (e.g., air interface). Depending on the nature of the UE 1000 (e.g., IoT device, enhanced mobile broadband (eMBB) device, ultra-reliable low-latency communication (URLLC) device, reduced capability device, etc.), an optional user interface 1012 (e.g., keypad, display, speaker, microphone, joystick) may also be provided and is connected via bus interface 1008 to bus 1002.

The computer-readable medium 1006 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1006 may reside in the processing system 1014, external to the processing system 1014, or distributed across multiple entities including the processing system 1014. The computer-readable medium 1006 may be embodied in a computer program product. By way of example, a computer program product may include a computer-readable medium in packaging materials. In some examples, the computer-readable medium 1006 may be part of the memory 1005. Those skilled in the art will recognize how best to implement the described functionality presented throughout this disclosure depending on the particular application and the overall design constraints imposed on the overall system. In some examples, the computer-readable medium 1006 may be implemented on an article of manufacture, which may further include one or more other elements or circuits, such as the processor 1004 and/or memory 1005.

The computer-readable medium 1006 may store computer-executable code (e.g., software). Software shall be construed broadly to mean instructions, instruction sets, code, code segments, program code, programs, subprograms, software modules, applications, software applications, software packages, routines, subroutines, objects, executables, threads of execution, procedures/processes, functions, etc., whether referred to as software, firmware, middleware, microcode, hardware description language, or otherwise.

One or more processors, such as processor 1004, may be responsible for managing the bus 1002 and general processing, including the execution of the software (e.g., instructions or computer-executable code) stored on the computer-readable medium 1006. The software, when executed by the processor 1004, causes the processing system 1014 to perform the various processes and functions described herein for any particular apparatus. The computer-readable medium 1006 and/or the memory 1005 may also be used for storing data that may be manipulated by the processor 1004 when executing software. For example, the memory 1005 may store one or more of individual RAT wake-up periodicities 1022 in mixed CA scenarios involving different frequency ranges (e.g., FR1 and FR2), and a joint RAT wake-up periodicity 1022 for use by the processor 1004 when the UE is operating in DRX mode (e.g., C-DRX mode).

In some aspects of the disclosure, the processor 1004 may include circuitry configured for various functions. For example, the processor 1004 may include communication and processing circuitry 1042, configured to communicate with a network entity (e.g., an aggregated or disaggregated base station, such as a gNB or eNB or one or more TRPs (e.g., cells)). In some examples, the communication and processing circuitry 1042 may include one or more hardware components that provide the physical structure that performs processes related to wireless communication (e.g., signal reception and/or signal transmission) and signal processing (e.g., processing a received signal and/or processing a signal for transmission). For example, the communication and processing circuitry 1042 may include one or more transmit/receive chains.

In some implementations where the communication involves receiving information, the communication and processing circuitry 1042 may obtain information from a component of the UE 1000 (e.g., from the transceiver 1010 that receives the information via radio frequency signaling or some other type of signaling suitable for the applicable communication medium), process (e.g., decode) the information, and output the processed information. For example, the communication and processing circuitry 1042 may output the information to another component of the processor 1004, to the memory 1005, or to the bus interface 1008. In some examples, the communication and processing circuitry 1042 may receive one or more of signals, messages, other information, or any combination thereof. In some examples, the communication and processing circuitry 1042 may receive information via one or more channels. In some examples, the communication and processing circuitry 1042 may include functionality for a means for receiving. In some examples, the communication and processing circuitry 1042 may include functionality for a means for processing, including a means for demodulating, a means for decoding, etc.

In some implementations where the communication involves sending (e.g., transmitting) information, the communication and processing circuitry 1042 may obtain information (e.g., from another component of the processor 1004, the memory 1005, or the bus interface 1008), process (e.g., modulate, encode, etc.) the information, and output the processed information. For example, the communication and processing circuitry 1042 may output the information to the transceiver 1010 (e.g., that transmits the information via radio frequency signaling or some other type of signaling suitable for the applicable communication medium). In some examples, the communication and processing circuitry 1042 may send one or more of signals, messages, other information, or any combination thereof. In some examples, the communication and processing circuitry 1042 may send information via one or more channels. In some examples, the communication and processing circuitry 1042 may include functionality for a means for sending (e.g., a means for transmitting). In some examples, the communication and processing circuitry 1042 may include functionality for a means for generating, including a means for modulating, a means for encoding, etc.

In some examples, the communication and processing circuitry 1042 may be configured to communicate with a first cell using a first RAT associated with a first FR (e.g., FR1) and a second cell using a second RAT associated with a second FR (e.g., FR2) in a DRX mode (e.g., C-DRX mode). The communication and processing circuitry 1042 may further be configured to receive and process at least one reference signal (e.g., SSB) from the base station during, for example, a tracking loop update procedure. For example, the communication and processing circuitry 1042 may be configured to receive at least one first SSB in the first FR (e.g., FR1) from the first cell and at least one second SSB in the second FR (e.g., FR2) from the second cell during a joint warm-up occasion. The communication and processing circuitry 1042 may further be configured to execute communication and processing instructions (software) 1052 stored in the computer-readable medium 1006 to implement one or more of the functions described herein.

The processor 1004 may further include DRX circuitry 1044, configured to implement an I-DRX mode or C-DRX mode on the UE 1000. In C-DRX mode, the DRX circuitry 1044 can be configured to determine a DRX cycle including a DRX ON duration and a DRX OFF duration. The DRX cycle may be determined, for example, based on DRX parameters received from the network entity. Upon entering the DRX ON duration at a system time corresponding to a start of the DRX ON duration, the DRX circuitry 1044 may be configured to wake-up the UE 1000 to enter an active state (e.g., awake state). For example, the DRX circuitry 1044 may be configured to control the power source 1030 to perform a power-up operation of one or more components of the UE 1000, such as the transceiver 1010, to enable monitoring and reception of a PDCCH in the DRX ON duration. At the end of the DRX ON duration at a system time corresponding to a start of the DRX OFF duration, the DRX circuitry 1044 may further be configured to control the power source 1030 to perform a power-down operation of the one or more components of the UE 1000 to enter a sleep state.

In addition, based on a wake-up periodicity for performing tracking loop updates (e.g., corresponding to an SSB periodicity), the DRX circuitry 1044 may be configured to identify a warm-up occasion prior to or after entering the DRX ON duration for performing tracking loop updates. During a warm-up occasion, the DRX circuitry 1044 may further be configured to control the power source 1030 to perform a power-up operation of one or more components of the UE 1000, such as the transceiver 1010, to enable monitoring and reception of a reference signal, such as an SSB. In addition, the DRX circuitry 1044 may configured to perform one or more tracking loop updates (e.g., TTL and/or FTL) during the warm-up occasion.

In mixed CA scenarios involving multiple RATs, each associated with a respective FR (e.g., FR1 and FR2), the DRX circuitry 1044 may be configured to identify a respective wake-up periodicity 1020 for each of the RATs and to further identify respective wake-up occasions for each of the RATs based on the respective wake-up periodicities. The DRX circuitry 1044 may further be configured to identify one or more joint warm-up occasions for both the first RAT and the second RAT. For example, the DRX circuitry 1044 may be configured to identify a joint wake-up periodicity 1022 for both the first RAT and the second RAT and to further identify one or more joint warm-up occasions based on the joint wake-up periodicity 1022. As another example, the DRX circuitry 1044 may be configured to identify a joint warm-up occasion based on modification of at least one of a first warm-up occasion associated with a first RAT and a second warm-up occasion associated with the second RAT. The DRX circuitry 1044 may further be configured to perform a respective TTL update and a respective FTL update for each of the first RAT and the second RAT based on respective SSBs (e.g., first SSB and second SSB) received in each FR (e.g., FR1 and FR2) during the joint warm-up occasion. The DRX circuitry 1044 may further be configured to execute DRX instructions (software) 1054 stored in the computer-readable medium 1006 to implement one or more of the functions described herein.

The processor 1004 may further include warm-up occasion modification circuitry 1046, configured to identify a first warm-up occasion for the first RAT and a second warm-up occasion for the second RAT in the DRX mode. Here, the second warm-up occasion occurs in a different DRX cycle than the first warm-up occasion. The warm-up occasion modification circuitry 1046 may further be configured to modify at least one of the first warm-up occasion or the second warm-up occasion to provide a joint warm-up occasion during a same DRX cycle for both the first RAT and the second RAT.

In some examples, the warm-up occasion modification circuitry 1046 may be configured to identify a first wake-up periodicity 1020 for the first RAT and a second wake-up periodicity 1020 for the second RAT. The warm-up occasion modification circuitry 1046 may further be configured to identify a joint wake-up periodicity 1022 for both the first RAT and the second RAT. The joint wake-up periodicity 1022 may be between the first wake-up periodicity and the second wake-up periodicity. In this example, the joint warm-up occasion may be one of a plurality of warm-up occasions defined by the joint wake-up periodicity.

In some examples, the warm-up occasion modification circuitry 1046 may select the joint wake-up periodicity 1022 to be an average of the first wake-up periodicity and the second wake-up periodicity. In other examples, the warm-up occasion modification circuitry 1046 may select the joint wake-up periodicity 1022 to be a maximum of the first wake-up periodicity and the second wake-up periodicity. In still other examples, the warm-up occasion modification circuitry 1046 may select the joint wake-up periodicity 1022 to be a minimum of the first wake-up periodicity and the second wake-up periodicity. The warm-up occasion modification circuitry 1046 may further be configured to dynamically modify the joint wake-up periodicity based on channel conditions of at least one of the first RAT or the second RAT.

In some examples, the warm-up occasion modification circuitry 1046 may be configured to prior to the first warm-up occasion, perform an evaluation of one or more key performance indicators (KPIs) related to the second RAT. The KPIs may include, for example, channel conditions, such as RSRP, RSRQ, SINR, or time/frequency drifts or other suitable KPIs, such as beam rotation or sensor inputs from the UE 1000 that may indicate whether the UE is moving. The warm-up occasion modification circuitry 1046 may further be configured to modify the second warm-up occasion to occur within the same DRX cycle as the first warm-up occasion to provide the joint warm-up occasion based on the evaluation. In addition, the warm-up occasion modification circuitry 1046 may be configured to skip one or more next warm-up occasions for the second RAT that are scheduled to occur within one or more next DRX cycles following the same DRX cycle based on a wake-up periodicity of the second RAT. The warm-up occasion modification circuitry 1046 may further be configured to execute warm-up occasion modification instructions (software) 1056 stored in the computer-readable medium 1006 to implement one or more of the functions described herein.

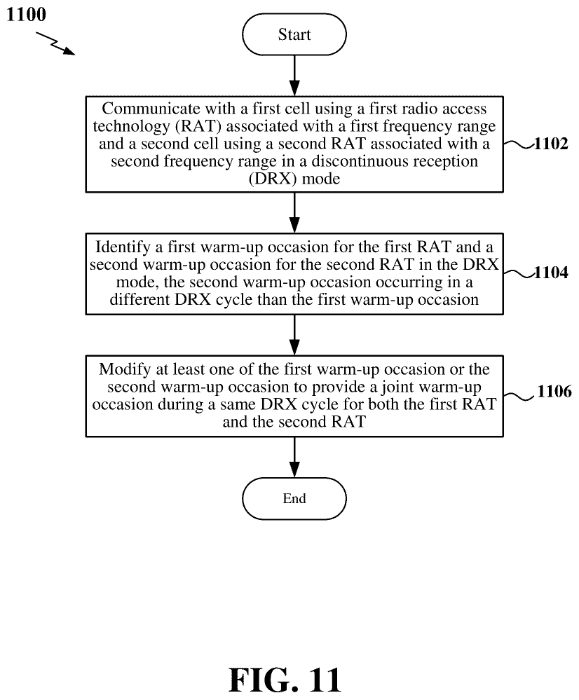

FIG. 11 is a flow chart of an exemplary method 1100 for modifying DRX warm-up timing in mixed carrier aggregation scenarios according to some aspects. As described below, some or all illustrated features may be omitted in a particular implementation within the scope of the present disclosure, and some illustrated features may not be required for implementation of all examples. In some examples, the method may be performed by the wireless communication device (e.g., UE) 1000, as described above and illustrated in FIG. 10, by a processor or processing system, or by any suitable means for carrying out the described functions.

At block 1102, the UE may communicate with a first cell using a first radio access technology (RAT) associated with a first frequency range and a second cell using a second RAT associated with a second frequency range in a discontinuous reception (DRX) mode. In some examples, the DRX mode may be a C-DRX mode. For example, the communication and processing circuitry 1042 together with the DRX circuitry 1044 and transceiver 1010, shown and described above in connection with FIG. 10 may provide a means to communicate with the first cell and the second cell.

At block 1104, the UE may identify a first warm-up occasion for the first RAT and a second warm-up occasion for the second RAT in the DRX mode, where the second warm-up occasion occurs in a different DRX cycle than the first warm-up occasion. In some examples, the UE may identify a first wake-up periodicity for the first RAT and a second wake-up periodicity for the second RAT. For example, the DRX circuitry 1044, together with the warm-up occasion modification circuitry 1046, shown and described above in connection with FIG. 10 may provide a means to identify the first and second warm-up occasions.

At block 1106, the UE may modify at least one of the first warm-up occasion or the second warm-up occasion to provide a joint warm-up occasion during a same DRX cycle for both the first RAT and the second RAT. In some examples, the UE may identify a joint wake-up periodicity for both the first RAT and the second RAT. The joint wake-up periodicity may be between the first wake-up periodicity and the second wake-up periodicity. Here, the joint warm-up occasion may be one of a plurality of warm-up occasions defined by the joint wake-up periodicity. In some examples, the joint wake-up periodicity is an average of the first wake-up periodicity and the second wake-up periodicity. In some examples, the joint wake-up periodicity is a maximum of the first wake-up periodicity and the second wake-up periodicity. In some examples, the joint wake-up periodicity is a minimum of the first wake-up periodicity and the second wake-up periodicity. In some examples, the UE may further modify the joint wake-up periodicity based on channel conditions of at least one of the first RAT or the second RAT.

In some examples, prior to the first warm-up occasion, the UE may perform an evaluation of one or more key performance indicators related to the second RAT. The UE may further modify the second warm-up occasion to occur within the same DRX cycle as the first warm-up occasion to provide the joint warm-up occasion based on the evaluation. In addition, the UE may skip one or more next warm-up occasions for the second RAT that are scheduled to occur within one or more next DRX cycles following the same DRX cycle based on a wake-up periodicity of the second RAT. For example, the warm-up occasion modification circuitry 1046 shown and described above in connection with FIG. 10 may provide a means to provide the joint warm-up occasion.

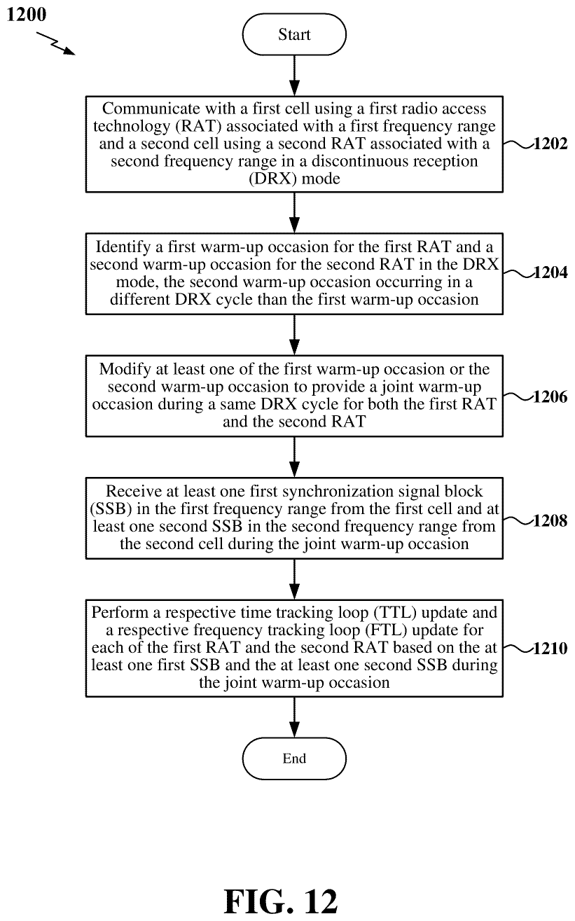

FIG. 12 is a flow chart of an exemplary method 1200 for performing tracking loop updates using modified DRX warm-up timing in mixed carrier aggregation scenarios according to some aspects. As described below, some or all illustrated features may be omitted in a particular implementation within the scope of the present disclosure, and some illustrated features may not be required for implementation of all examples. In some examples, the method may be performed by the wireless communication device (e.g., UE) 1000, as described above and illustrated in FIG. 10, by a processor or processing system, or by any suitable means for carrying out the described functions.

At block 1202, the UE may communicate with a first cell using a first radio access technology (RAT) associated with a first frequency range and a second cell using a second RAT associated with a second frequency range in a discontinuous reception (DRX) mode. In some examples, the DRX mode may be a C-DRX mode. For example, the communication and processing circuitry 1042 together with the DRX circuitry 1044 and transceiver 1010, shown and described above in connection with FIG. 10 may provide a means to communicate with the first cell and the second cell.

At block 1204, the UE may identify a first warm-up occasion for the first RAT and a second warm-up occasion for the second RAT in the DRX mode, where the second warm-up occasion occurs in a different DRX cycle than the first warm-up occasion. In some examples, the UE may identify a first wake-up periodicity for the first RAT and a second wake-up periodicity for the second RAT. For example, the DRX circuitry 1044, together with the warm-up occasion modification circuitry 1046, shown and described above in connection with FIG. 10 may provide a means to identify the first and second warm-up occasions.

At block 1206, the UE may modify at least one of the first warm-up occasion or the second warm-up occasion to provide a joint warm-up occasion during a same DRX cycle for both the first RAT and the second RAT. In some examples, the UE may identify a joint wake-up periodicity for both the first RAT and the second RAT. The joint wake-up periodicity may be between the first wake-up periodicity and the second wake-up periodicity. Here, the joint warm-up occasion may be one of a plurality of warm-up occasions defined by the joint wake-up periodicity. In some examples, the joint wake-up periodicity is an average of the first wake-up periodicity and the second wake-up periodicity. In some examples, the joint wake-up periodicity is a maximum of the first wake-up periodicity and the second wake-up periodicity. In some examples, the joint wake-up periodicity is a minimum of the first wake-up periodicity and the second wake-up periodicity. In some examples, the UE may further modify the joint wake-up periodicity based on channel conditions of at least one of the first RAT or the second RAT.

In some examples, prior to the first warm-up occasion, the UE may perform an evaluation of one or more key performance indicators related to the second RAT. The UE may further modify the second warm-up occasion to occur within the same DRX cycle as the first warm-up occasion to provide the joint warm-up occasion based on the evaluation. In addition, the UE may skip one or more next warm-up occasions for the second RAT that are scheduled to occur within one or more next DRX cycles following the same DRX cycle based on a wake-up periodicity of the second RAT. For example, the warm-up occasion modification circuitry 1046 shown and described above in connection with FIG. 10 may provide a means to provide the joint warm-up occasion.

At block 1208, the UE may receive at least one first synchronization signal block (SSB) in the first frequency range from the first cell and at least one second SSB in the second frequency range from the second cell during the joint warm-up occasion. For example, the communication and processing circuitry 1042, together with the DRX circuitry 1044 and the transceiver 1010, shown and described above in connection with FIG. 10 may provide a means to receive the first and second SSBs.

At block 1210, the UE may perform a respective time tracking loop (TTL) update and a respective frequency tracking loop (FTL) update for each of the first RAT and the second RAT based on the at least one first SSB and the at least one second SSB during the joint warm-up occasion. For example, the DRX circuitry 1044 shown and described above in connection with FIG. 10 may provide a means to perform respective tracking loops during the joint warm-up occasion.

In one configuration, the UE 1000 includes means for communicating with a first cell using a first radio access technology (RAT) associated with a first frequency range and a second cell using a second RAT associated with a second frequency range in a discontinuous reception (DRX) mode, means for identifying a first warm-up occasion for the first RAT and a second warm-up occasion for the second RAT in the DRX mode, the second warm-up occasion occurring in a different DRX cycle than the first warm-up occasion, and means for modifying at least one of the first warm-up occasion or the second warm-up occasion to provide a joint warm-up occasion during a same DRX cycle for both the first RAT and the second RAT. In one aspect, the aforementioned means may be the processor 1004 shown in FIG. 10 configured to perform the functions recited by the aforementioned means. In another aspect, the aforementioned means may be a circuit or any apparatus configured to perform the functions recited by the aforementioned means.

Of course, in the above examples, the circuitry included in the processor 1004 is merely provided as an example, and other means for carrying out the described functions may be included within various aspects of the present disclosure, including but not limited to the instructions stored in the computer-readable medium 1006, or any other suitable apparatus or means described in any one of the FIGS. 1, 2 and/or 6, and utilizing, for example, the processes and/or algorithms described herein in relation to FIGS. 11 and/or 12.

The following provides an overview of examples of the present disclosure.

Example 1: A method for wireless communication at a user equipment, the method comprising: communicating with a first cell using a first radio access technology (RAT) associated with a first frequency range and a second cell using a second RAT associated with a second frequency range in a discontinuous reception (DRX) mode; identifying a first warm-up occasion for the first RAT and a second warm-up occasion for the second RAT in the DRX mode, the second warm-up occasion occurring in a different DRX cycle than the first warm-up occasion; and modifying at least one of the first warm-up occasion or the second warm-up occasion to provide a joint warm-up occasion during a same DRX cycle for both the first RAT and the second RAT.

Example 2: The method of example 1, further comprising: identifying a first wake-up periodicity for the first RAT and a second wake-up periodicity for the second RAT; and identifying a joint wake-up periodicity for both the first RAT and the second RAT, the joint wake-up periodicity being between the first wake-up periodicity and the second wake-up periodicity, the joint warm-up occasion being one of a plurality of warm-up occasions defined by the joint wake-up periodicity.

Example 3: The method of example 2, wherein the joint wake-up periodicity is an average of the first wake-up periodicity and the second wake-up periodicity.

Example 4: The method of example 2, wherein the joint wake-up periodicity comprises a maximum of the first wake-up periodicity and the second wake-up periodicity.

Example 5: The method of example 2, wherein the joint wake-up periodicity comprises a minimum of the first wake-up periodicity and the second wake-up periodicity.

Example 6: The method of any of examples 2 through 5, further comprising: modifying the joint wake-up periodicity based on channel conditions of at least one of the first RAT or the second RAT.

Example 7: The method of example 1, wherein the modifying the at least one of the first warm-up occasion or the second warm-up occasion to provide the joint warm-up occasion further comprises: prior to the first warm-up occasion, performing an evaluation of one or more key performance indicators related to the second RAT; and modifying the second warm-up occasion to occur within the same DRX cycle as the first warm-up occasion to provide the joint warm-up occasion based on the evaluation.

Example 8: The method of example 7, further comprising: skipping one or more next warm-up occasions for the second RAT that are scheduled to occur within one or more next DRX cycles following the same DRX cycle based on a wake-up periodicity of the second RAT.

Example 9: The method of any of examples 1 through 8, wherein the DRX mode is a connected DRX (C-DRX) mode.

Example 10: The method of any of examples 1 through 9, further comprising: receiving at least one first synchronization signal block (SSB) in the first frequency range from the first cell and at least one second SSB in the second frequency range from the second cell during the joint warm-up occasion; and performing a respective time tracking loop (TTL) update and a respective frequency tracking loop (FTL) update for each of the first RAT and the second RAT based on the at least one first SSB and the at least one second SSB during the joint warm-up occasion.

Example 11: A user equipment (UE) configured for wireless communication comprising a wireless transceiver, a memory, and processor coupled to the wireless transceiver and the memory, the processor being configured to perform a method of any one of examples 1 through 10.

Example 12: A user equipment (UE) comprising at least one means for performing a method of any one of examples 1 through 10.

Example 13: A non-transitory computer-readable medium having stored therein instructions executable by one or more processors of a user equipment (UE) to perform a method of any one of examples 1 through 10.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-12 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1, 2, and 6 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b, and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A user equipment (UE) configured for wireless communication, comprising:
a wireless transceiver;
a memory; and
a processor coupled to the wireless transceiver and the memory, the processor being configured to:
communicate with a first cell using a first radio access technology (RAT) associated with a first frequency range and a second cell using a second RAT associated with a second frequency range in a discontinuous reception (DRX) mode;
identify a first warm-up occasion for the first RAT and a second warm-up occasion for the second RAT in the DRX mode, the second warm-up occasion occurring in a different DRX cycle than the first warm-up occasion; and
modify at least one of the first warm-up occasion or the second warm-up occasion to provide a joint warm-up occasion during a same DRX cycle for both the first RAT and the second RAT.

2. The UE of claim 1, wherein the processor is further configured to:
identify a first wake-up periodicity for the first RAT and a second wake-up periodicity for the second RAT; and
identify a joint wake-up periodicity for both the first RAT and the second RAT, the joint wake-up periodicity being between the first wake-up periodicity and the second wake-up periodicity, the joint warm-up occasion being one of a plurality of warm-up occasions defined by the joint wake-up periodicity.

3. The UE of claim 2, wherein the joint wake-up periodicity is an average of the first wake-up periodicity and the second wake-up periodicity.

4. The UE of claim 2, wherein the joint wake-up periodicity comprises a maximum of the first wake-up periodicity and the second wake-up periodicity.

5. The UE of claim 2, wherein the joint wake-up periodicity comprises a minimum of the first wake-up periodicity and the second wake-up periodicity.

6. The UE of claim 2, wherein the processor is further configured to:
modify the joint wake-up periodicity based on channel conditions of at least one of the first RAT or the second RAT.

7. The UE of claim 1, wherein the processor is further configured to:
prior to the first warm-up occasion, perform an evaluation of one or more key performance indicators related to the second RAT; and
modify the second warm-up occasion to occur within the same DRX cycle as the first warm-up occasion to provide the joint warm-up occasion based on the evaluation.

8. The UE of claim 7, wherein the processor is further configured to:
skip one or more next warm-up occasions for the second RAT that are scheduled to occur within one or more next DRX cycles following the same DRX cycle based on a wake-up periodicity of the second RAT.

9. The UE of claim 1, wherein the DRX mode is a connected DRX (C-DRX) mode.

10. The UE of claim 1, wherein the processor is further configured to:
receive at least one first synchronization signal block (SSB) in the first frequency range from the first cell and at least one second SSB in the second frequency range from the second cell during the joint warm-up occasion; and
perform a respective time tracking loop (TTL) update and a respective frequency tracking loop (FTL) update for each of the first RAT and the second RAT based on the at least one first SSB and the at least one second SSB during the joint warm-up occasion.

11. A method for wireless communication at a user equipment (UE), the method comprising:
communicating with a first cell using a first radio access technology (RAT) associated with a first frequency range and a second cell using a second RAT associated with a second frequency range in a discontinuous reception (DRX) mode;
identifying a first warm-up occasion for the first RAT and a second warm-up occasion for the second RAT in the DRX mode, the second warm-up occasion occurring in a different DRX cycle than the first warm-up occasion; and
modifying at least one of the first warm-up occasion or the second warm-up occasion to provide a joint warm-up occasion during a same DRX cycle for both the first RAT and the second RAT.

12. The method of claim 11, further comprising:
identifying a first wake-up periodicity for the first RAT and a second wake-up periodicity for the second RAT; and
identifying a joint wake-up periodicity for both the first RAT and the second RAT, the joint wake-up periodicity being between the first wake-up periodicity and the second wake-up periodicity, the joint warm-up occasion being one of a plurality of warm-up occasions defined by the joint wake-up periodicity.

13. The method of claim 12, wherein the joint wake-up periodicity is an average of the first wake-up periodicity and the second wake-up periodicity.

14. The method of claim 12, wherein the joint wake-up periodicity comprises a maximum of the first wake-up periodicity and the second wake-up periodicity.

15. The method of claim 12, wherein the joint wake-up periodicity comprises a minimum of the first wake-up periodicity and the second wake-up periodicity.

16. The method of claim 12, further comprising:
modifying the joint wake-up periodicity based on channel conditions of at least one of the first RAT or the second RAT.

17. The method of claim 11, wherein the modifying the at least one of the first warm-up occasion or the second warm-up occasion to provide the joint warm-up occasion further comprises:
prior to the first warm-up occasion, performing an evaluation of one or more key performance indicators related to the second RAT; and
modifying the second warm-up occasion to occur within the same DRX cycle as the first warm-up occasion to provide the joint warm-up occasion based on the evaluation.

18. The method of claim 17, further comprising:
skipping one or more next warm-up occasions for the second RAT that are scheduled to occur within one or more next DRX cycles following the same DRX cycle based on a wake-up periodicity of the second RAT.

19. (canceled)

20. The method of claim 11, further comprising:
receiving at least one first synchronization signal block (SSB) in the first frequency range from the first cell and at least one second SSB in the second frequency range from the second cell during the joint warm-up occasion; and
performing a respective time tracking loop (TTL) update and a respective frequency tracking loop (FTL) update for each of the first RAT and the second RAT based on the at least one first SSB and the at least one second SSB during the joint warm-up occasion.

21. A user equipment (UE), comprising:
means for communicating with a first cell using a first radio access technology (RAT) associated with a first frequency range and a second cell using a second RAT associated with a second frequency range in a discontinuous reception (DRX) mode;
means for identifying a first warm-up occasion for the first RAT and a second warm-up occasion for the second RAT in the DRX mode, the second warm-up occasion occurring in a different DRX cycle than the first warm-up occasion; and
means for modifying at least one of the first warm-up occasion or the second warm-up occasion to provide a joint warm-up occasion during a same DRX cycle for both the first RAT and the second RAT.

22. (canceled)

23. (canceled)

24. (canceled)

25. (canceled)

26. (canceled)

27. (canceled)

28. (canceled)

29. (canceled)

30. (canceled)
